(19) United States
(12) Patent Application Publication
(10) Pub. No.: US 2005/0143090 A1
(43) Pub. Date: Jun. 30, 2005

(54) Location aided wireless signal characteristic adjustment

(75) Inventor: Martin J. Dowling, Plymouth Meeting, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/747,299

(22) Filed: Dec. 29, 2003

(51) Int. Cl. H04Q 7/20

(52) U.S. Cl. 455/456.1; 455/436

(57) ABSTRACT

Location data is used to augment signal parameter measurement and signal control of wireless transmit/receive units (WTRUs). When communication between a base station and the WTRU is established and a location of the WTRU is obtained by the base station, the data is correlated to a database. The correlated data is used to predict changes in signal parameters and the anticipated changes are used to provide adjustments in communication signals between the base station and the WTRU.

### FIELD OF INVENTION

The present invention relates to control of signal parameters in wireless communication systems. More particularly, the invention relates to adjusting received signal characteristics based on location information.

### BACKGROUND

In wireless communication systems, parameter measurement is essential to the efficient operation of the system. These parameters include, bit error rates (BERs), block error rates (BLERs), signal to interference ratio (SIR) measurements, Doppler shifts, etc. To illustrate, in many wireless communication systems, the block error rate is used to determine whether transmission power levels need to be increased or decreased. A high BLER results in an increase in power and a low BLER results in a decrease in power. The use of the BLER measurements helps the wireless system maintain an efficient trade off between transmission power levels and system capacity.

A delay exists in adjusting for significant changes in the signal characteristics. For example, it takes many (e.g., 40) frames to complete an automatic frequency control (AFC) adjustment, and a number of frames for power control to correct for a deep fade (depending on the delay and averaging parameters). The fade may actually be over by the time the Doppler frequency compensation or power level converges to the correct value.

Accordingly, it is desirable to have alternate approaches to adjusting wireless signal characteristics.

### SUMMARY

A wireless communication system uses location information in order to provide signal control parameters based on the anticipated movement of a wireless transmit receive unit (WTRU). A signal connection is established between a WTRU and a base station, and a location of the WTRU is obtained. The location is correlated with a database to obtain the anticipated movement of the WTRU.

In a particular embodiment of the invention, the correlation of the location includes mapping the location to a database and correlating the location and the database to obtain anticipated movement of the WTRU.

### BRIEF DESCRIPTION OF THE DRAWING(S)

FIG. 1 is a diagram showing an illustrative wireless signal propagation environment.

FIG. 2 is a flow chart for location aided wireless measurements.

FIG. 3 is a simplified diagram of a location aided wireless measurement system.

### DETAILED DESCRIPTION OF THE PREFERRED EMBODIMENT(S)

The present invention is useful in wireless communication systems, such as in conjunction with a third generation partnership program (3GPP) wideband code division multiple access (W-CDMA) system. Hereafter, a WTRU includes but is not limited to a user equipment, mobile station, fixed or mobile subscriber unit, pager, or any other type of device capable of operating in a wireless environment. A base station includes but is not limited to a Node-B, site controller, access point or other interfacing device in a wireless environment.

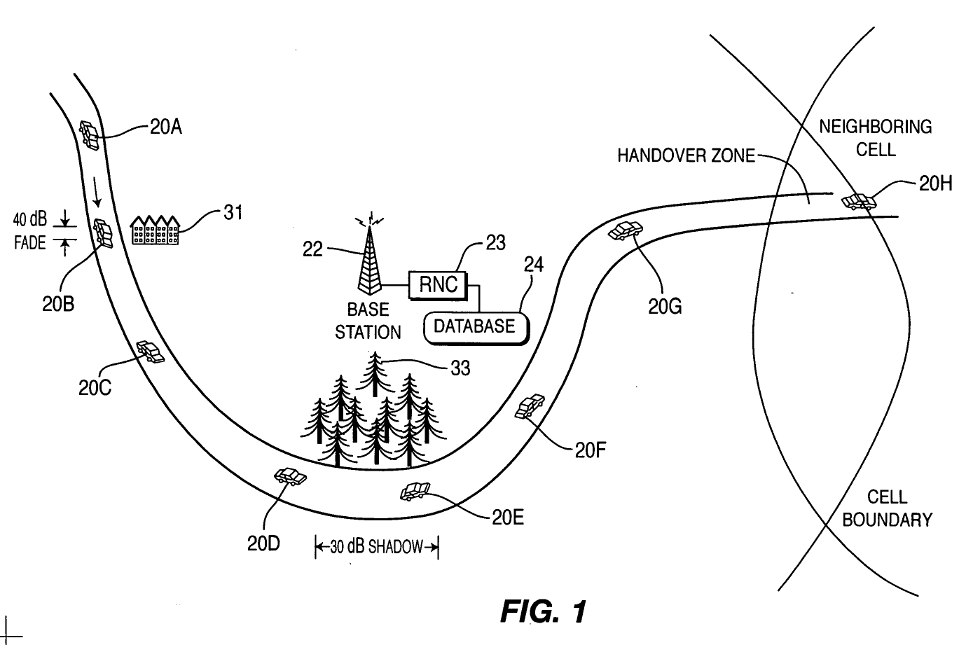

FIG. 1 is an illustration of applying location aided channel condition measurements. As illustrated in FIG. 1, a WTRU 20 (indicated at positions 20A through 20G) is traveling along a highway in a cell serviced by a base station 22, which is in turn in operative communication with a radio network controller (RNC) 23 which has access to a database 24. The database 24 includes a correlation between locations and relative signal strengths and between locations and anticipated future locations (travel paths).

As the WTRU 20 travels along the highway as illustrated by the arrow (from generally left to generally right), from position 20A to position 20B, a localized obstruction 31, such as a building, causes a deep fade. The deep fade would likely result in a short duration high BER, high BLER and low SIR. The effects of obstruction 31 diminish, at position 20C. As the WTRU 20 continues along the highway, it encounters a dense wooded area 33, at positions which include 20D and 20E. Due to the varying nature of the wooded area 33, each position 20D, 20E may encounter differing channel conditions. At position 20F, the WTRU 20 continues along the highway in a transverse direction with respect to base station 23, towards position 20G in a longitudinal position with respect to base station 23, the WTRU 20 begins to experience a Doppler shift as it moves at a fast rate away from the base station 23. At position 20H, the WTRU 20 moves to a handover zone, which results in another Doppler shift as a result of a handover. After handover, another Doppler shift occurs. Prior to handover the WTRU 20 is moving quickly away from the base station 22. After handover, the WTRU 20 is moving quickly towards the neighboring cell's base station.

In accordance with one aspect of the present invention, the base station 22 is able to correlate its database with an anticipated path of the WTRU 20. Thus if a WTRU 20 had moved from position 20A to position 20B, one could conclude that it is likely that the WTRU 20 will follow the roadway. The base station 22 correlates the present and previous locations, e.g. locations 20A and 20B with the data in the database 24, and determines anticipated locations for the WTRU, such as location 20C.

The RNC can anticipate future locations o f the WTRU 20 by, for example, (a) using the location and direction of motion to project the future path based on linear or non-linear extrapolation, or (b) employing a statistical approach in which, given the present location and direction of travel, and based on past behavior of previous WTRUs at that location and moving in that direction, empirically determining the probability of this WTRU 20 passing through a specified location, or (c) correlating the WTRU 20's path with known paths of the area (such as from a map) and determining that the WTRU 20 is following a known path. The base station 22 uses the anticipated locations to provide signal control parameters in accordance with the anticipated locations.

While the above description has the base station 22 making the correlations, it is understood that the location of the database and the specific part of the network which makes the determinations of anticipated location and signal parameters may be elsewhere on the network. For example, the determination of anticipated location may be made by the RNC 23 or the database 24 can be at the base station 22.

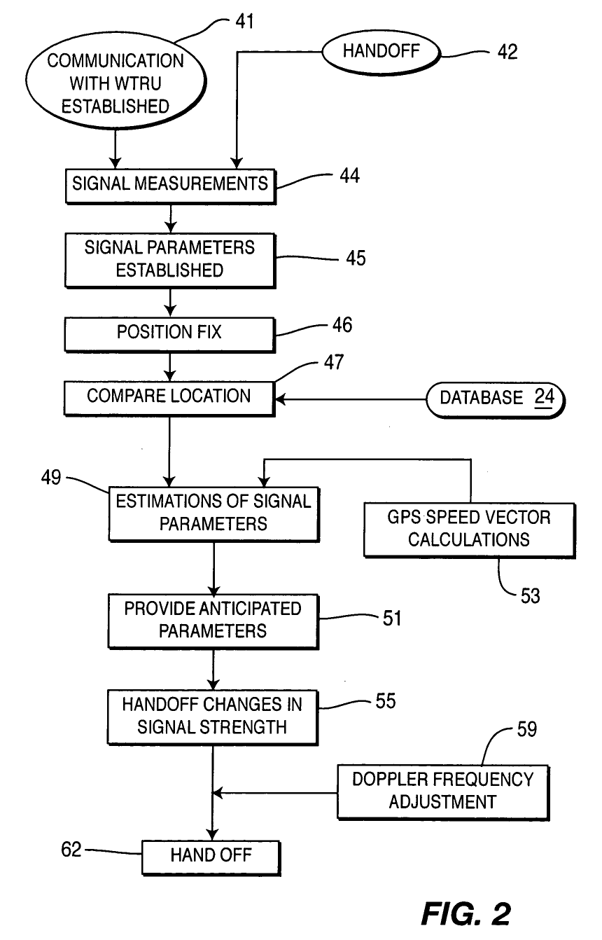

FIG. 2 is a flow diagram of location aided measurements. A base station 23 acquires a WTRU 20 (step 41), typically by establishing communications with the WTRU 20 or through a handoff (indicated as step 42). The base station and WTRU 20 establish signal parameters (steps 44 and 45) based on signal measurements. The WTRU 20 provides the base station 22 or RNC 23 with GPS location, or location information for the WTRU 20 is otherwise determined by the base station 22/RNC 23 (step 46). The base station 23 then compares the location of the WTRU 20 as provided in step 46 with the database 24 (step 47). The comparison of the location of the WTRU 20 with the database 24 provides an indication of the environmental effects on the signals transmitted to and from the WTRU 20 and are correlated with the signal parameters determined in steps 44 and 45. As the WTRU 20 progresses, the WTRU 20 provides the base station 23 with updated position information. The base station makes estimates of changes in signal parameters based on the new positions (step 49), and is able to provide estimates as to future locations of the WTRU 20 (step 51).

Optionally, the WTRU 20 provides directional movement data to the base station 22/RNC 23, such as by global positioning system (GPS) sensing (step 53). This data concerning movement is correlated by the base station 23 with data from the database 24 so as to provide more precise indications of movement of the WTRU 20. Optionally, the WTRU 20 may also interpolate between GPS readings based on monitoring its vehicle's direction and speed, or based on a parameter versus distance or versus time function on that path communicated to the WTRU 20 from base station 22/RNC 23.

For a handoff, the base station 22 or RNC 23 provides the WTRU 20 with data related to the change in signal strength (step 55) and other parameters, including Doppler frequency adjustment (step 59) and hands off the WTRU 20 (step 62). Optionally, the base station 22 or RNC 23 also provides the WTRU 20 with cell synchronization information of the new cell, such as a scrambling code and frequency of a broadcast channel for 3GPP W-CDMA systems.

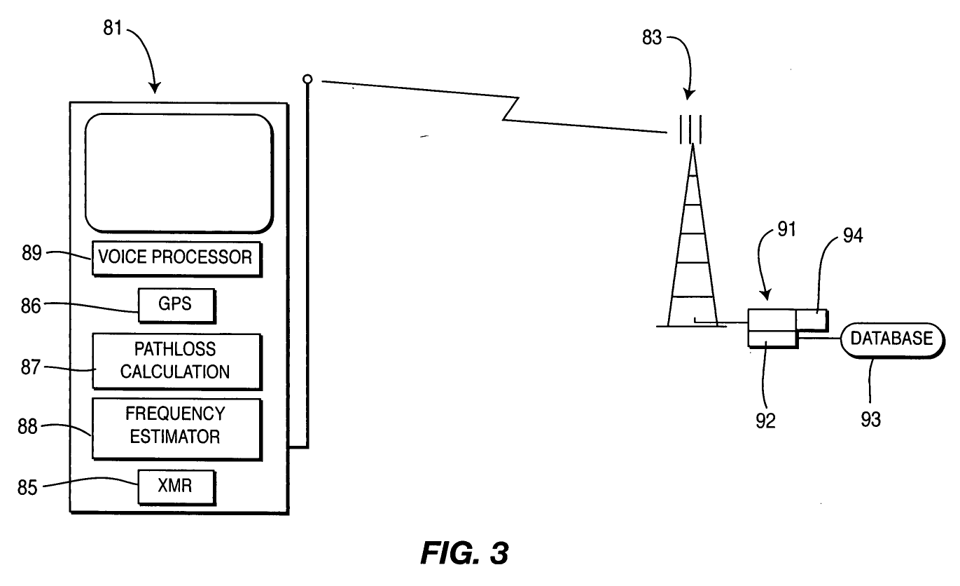

FIG. 3 is a schematic block diagram showing a WTRU 81 and base station 83 The WTRU 81 includes transmit receive circuitry 85, and a location determining device, such as GPS receiver 86. The WTRU 86 also includes signal analysis circuitry, such as path loss calculation circuit 87, frequency estimator 88 and voice processing circuitry 89. These components may be integrated into a common circuit, and may use a common processor to implement some or all of these components. The WTRU 81 provides the base station 83 with data relating to signal measurements as well as the GPS data (via GPS receiver 86), and receives signal parameters from the base station 83. The base station 83 has transmit/receive circuitry 91, a processor 92 and has access to a database 93. In some configurations, the base station 83 may have a locating device 94 for determining locations of the WTRU 81. The base station 83 uses data concerning the location from the WTRU 81 and from the locating device 94 to determine a location of the WTRU 81. In addition, the database 93 can be used to estimate the location of the WTRU 81. The WTRU 81 provides signal parameter data and signal strength estimations based on the actual signal measurements as combined with data obtained from the database 93.

For certain measurements, other factors may affect the measurement. To illustrate, an interference measurement, such as interference signal code power (ISCP), made during peak hours may have little correlation to off peak hours, such as at night. Accordingly, a time of the day of the measurements may be stored so that only measurements reflecting similar channel conditions are combined. Another factor may be the weather. Measurements taken during a thunderstorm may vary significantly from measurements taken during a sunny day. As a result, a factor representing the weather conditions may be stored along with the measurements. Other factors include cell loading, speed of the WTRU 20 and the type of WTRU 20 taking the measurement.

In one embodiment, the system uses WTRUs 20 capable of location determination. The WTRU 20 allows their location information to be transmitted to the serving cell. In return for providing location information, the users receive better quality of service, avoidance of dropouts, superior emergency and convenience services, and an extension of battery life. The WTRU 20 periodically transmits its location information to the serving cell (and the RNC 23) on a control channel, which is typically available on the communication link between the WTRU 20 and the base station 22. In some instances an accurate location determination may not be possible. As a result, the network or WTRU may estimate the WTRU's location by past measurements and a movement vector.

According to one embodiment, a WTRU 20 sends its coordinates to the base station while in motion and the RNC 23 identifies not only where the WTRU 20 is, but where it is going (direction and velocity can be calculated either in the WTRU 20 or RNC 23). The RNC 23 has access to a database which provides information concerning where predictable fades and Doppler shifts occur in the cell because of the detailed survey, such as performed by a roving monitor during site acceptance tests and annual surveys thereafter. The cell fixed monitors (which have an established mathematical relationship with the survey baseline) provide current state information to the RNC 23.

Based on this information, the RNC 23 warns the WTRU 20 of approaching fades and Doppler shifts, and indicates how to correct them, such as by a signal or message. Since the RNC 23 is aware of when a WTRU 20 is entering a section of road where the power changes precipitously, it can unilaterally change the downlink power to an approximately correct value to avoid the typical slow 1 dB step changes commanded by the WTRU 20 in the standard closed loop transmit power control process. This procedure avoids a possible call dropout due to an overpowering fade.

Similar advantages apply to other link controls, such as adaptive modulation and coding, in which coding and modulation are adjusted to reduce the information data rate in the presence of adverse environmental conditions. The invention forewarns the WTRU 20 that it is approaching an adverse condition and provides guidance to the WTRU 20 to adjust its coding and modulation, and by how much. Likewise when conditions improve, the invention guides the WTRU 20 to adjust its coding and modulation to take quick advantage of improved conditions thus increasing cell capacity.

As the RNC 23 collects information, it can determine heavily and lightly traveled routes, such as highways. This type of mapping can also be done on a site survey. Once the RNC 23 is aware of the routes, it can take fewer samples in areas with little parameter changes. For areas with high parameter changes, the RNC 23 may take more samples to fully characterize the transient. For example, a road perpendicular to a base station 22 that suddenly makes a turn toward or away from the base station 22 produces a Doppler transient in a traveling WTRU 20. A road that suddenly moves close to a busy interstate highway creates an interference transient. A road that moves behind a group of high rise buildings generates a power transient (fade).

The RNC's knowledge is preferably kept current. In one embodiment, stationary monitors are provided at key locations in the cell whose output is used to provide real time updates to the baseline data. On a long term basis, such updates acknowledge new roads, new tall buildings, etc. On a short term basis, updates report real time changes in the air interface conditions due to weather, temperature, interference, etc.

Using location adjustments allows the WTRU to take fewer measurements; work with more accurate information; and not be any less accurate in the case of discontinuous transmission (DTX) and sparse frame allocation where now it has to estimate the imprecise “virtual SIR”.

Faster outer loop power control, and improved downlink quality of service (QoS) is achieved by directly measuring the SIR BLER relationship. The initial downlink target SIR is largely based on relating BLER and initial target SIR, such as tables based on simulations.

The target SIR may be held constant for an extended period of time while the inner loop adjusts the downlink power to bring the SIR close to the target SIR. After this is done, the target SIR may be significantly off (in the sense that it is not producing the desired BLER). The location aided adjustment system may enter an algorithm that adaptively changes the target SIR step size. As a result, it may take a long time and numerous large and small steps to acquire the desired quality. The situation is worst for non real time data that may only last a few TTIs (transmission time intervals).

Location aided parameter adjustment directly relates the BLER to SIR. From its baseline survey, periodic updates, and statistics on WTRUs 20 traveling on certain roads in a particular direction (plus the interference and environment inputs from stationary monitors), the radio resource controller (RRC) can more accurately estimate the target SIR required to achieve the desired QoS, resulting in a dramatic improvement in speed and accuracy of corrections/adjustments.

In the downlink inner loop process, the WTRU commands the base station to increase or decrease power. With location aided adjustments, the RNC 23 looks up the correct power level based on the WTRU location. The power can be primarily adjusted by location updates rather than WTRU commands. The location based information can be occasionally verified, in a form of a confirmation check. The benefit is that both the signaling and WTRU internal calculations can be greatly reduced.

Instead of deploying monitors, the RNC 23 may learn the Doppler, power and other characteristics throughout the cell using measurements signaled by each WTRU 20. Each passing WTRU 20 is a learning experience. For example, to determine the relation between the target SIR and BLER at some stretch of a road, the UTRAN assigns T1 targetSIR to the first WTRU 20 and measures B1 BLER as a result. The UTRAN assigns T2 targetSIR to the next WTRU 20 and finds B2 BLER. As a result, the database 93 can be updated by the individual WTRU measurements.

Also, by way of example, to determine the relation between the target SIR and BLER at some stretch of a road, the UTRAN assigns T1 targetSIR to a first WTRU 20 and measures B1 BLER as a result. The UTRAN assigns T2 targetSIR to the next WTRU 20 and finds B2 BLER. A database 93 is developed which is the electronic equivalent to a graph at each X,Y location in the cell. After completion, the RNC 23 has good data concerning parameters with respect to WTRU locations and air interface conditions in the cell. As a result, the RNC 23 is in a position to perform the following functions.

A long fade will tend to destabilize the target SIR. Consider the case of a WTRU 20 moving temporarily into the shadow of a large hill or apartment complex. As the BLER will tend to temporarily increase, the RRC will tend to increase the target SIR to compensate. Using location aided adjustments, the RNC 23 has access to data indicating that the situation is temporary and can (a) freeze the outer loop, and (b) guide the inner loop through the disturbance. The guide information may be power steps or may be a power level profile representing a power versus distance or time curve for the duration of the fade.

Automatic frequency control (AFC) can utilize the data concerning the WTRU's location and anticipated path. Based on the WTRU location and rate of motion, the RNC can inform the WTRU of an upcoming Doppler shift. The WTRU can therefore be handed the approximate frequency correction rather than wait, say, 40 frames for a reliable calculated value. Since the approximate frequency correction value is initially used, the measured value is more quickly obtained and is therefore more current than would be achievable by prior art techniques.

The location information provides an indication as to when a WTRU 20 is making a change in movement. This information provides the RNC with an indication when a WTRU 20 is making a major change in direction that radically changes the doppler offset. The RNC 23 can instruct the WTRU 20 to jump to the appropriate frequency correction, thus avoiding the normal, say, 40, frame correction period and the possibility of losing synchronization. Since the RNC 23 knows when a WTRU 20 is making a major change in direction that radically changes the doppler offset, it can instruct the WTRU 20 to jump to the appropriate frequency correction, thus avoiding the normal multi-frame correction period and the possibility of losing synchronization.

Additionally, emergency calling services are improved in their ability to locate the WTRU 20 used to make the call. In case of an emergency services call, the RNC 23 not only knows the location of the caller, but, if the caller is moving, the caller's path if the caller is moving. Caller movement is relevant, for example, if the caller is fleeing an attacker, en route to a hospital or other physical facility, or otherwise moving. The police will want to know not only where the person is but where he or she is headed. Furthermore, if an emergency vehicle is trying to find a caller in a poorly known location, the cell can provide mapping directions from area hospitals and fire and police stations.

The location capabilities can be used to provide road information. The RNC 23 can warn a WTRU user approaching a stop sign, entering a congested area, nearing an icy or foggy strip, approaching a dangerous intersection, and in general coming into a dangerous or backed up area. It can do this by signaling a buzzer or text message to the user, or interrupting a call with one of a set of pre recorded terse audio messages. Working with a tour or travel information service, the RNC 23 can alert WTRUs 20 about detours and general slowdowns. Working with a traffic service, the RNC 23 can alert a WTRU 20 to accidents and suggest alternate routes.

1. A method for controlling signal parameters in a wireless system, the method comprising:
establishing a signal connection between a wireless transmit/receive unit (WTRU) and a base station;
obtaining a geopositional fix on the WTRU;
correlating the geopositional fix with a database to obtain anticipated movement of the WTRU; and
providing signal control parameters based on the anticipated movement.

2. The method of claim 1, wherein the correlation of the geopositional fix includes:
mapping the geopositional fix to the database; and
correlating the geopositional fix and the database to obtain anticipated movement of the WTRU.

3. The method of claim 2, comprising reducing a number of signal adjustments executed by the WTRU by using said signal control parameters based on the anticipated movement.

4. The method of claim 2, comprising:
using the database to determine anticipated transitory changes in signal values; and
using said signal control parameters to provide reduced changes in a target SIR in response to transitory changes.

5. The method of claim 2, comprising said signal control parameters providing a response to an anticipated change in Doppler shift based on geopositional data from the WTRU and data from the database.

6. The method of claim 2, comprising reducing a number of signal adjustments executed by the WTRU by using said signal control parameters based on the anticipated movement.

7. The method of claim 1 wherein said anticipated movement of said WTRU is obtained at least in part by empirically determining the probability of said WTRU moving to a location by correlating said positional fix and a travel vector of said WTRU with said database, said database containing statistics on the subsequent travel of previous WTRUs at that location and moving in that direction.

8. The method of claim 1 wherein said anticipated movement of said WTRU is obtained at least in part by correlating said WTRU's path with data concerning known paths on a map of the area contained within said database and thereby determining an anticipated path of said WTRU is following a known path.

9. The method of claim 1, further comprising using said anticipated movement to provide handoff information to the WTRU.

10. The method of claim 1, further comprising using a GPS receiver in the WTRU, and transmitting data obtained from the GPS receiver in order to obtain the geopositional fix.

11. The method of claim 1, further comprising obtaining the geopositional fix by effecting signal measurements at the base station.

12. The method of claim 1, further comprising using fixed monitors to provide measurements for the database.

13. A wireless communication system, capable of controlling signal parameters, comprising:
a circuit for establishing a signal connection with a wireless transmit/receive unit (WTRU) and at least one base station;
a circuit for obtaining from geopositional data of the WTRU;
a database including signal data correlated with geopositional data;
a circuit for correlating the geopositional data with the database to obtain anticipated movement of the WTRU; and
a circuit for providing signal control parameters based on the anticipated movement.

14. The wireless communications system of claim 13, wherein the circuit for correlating the geopositional data includes:
a comparison circuit function for mapping a geopositional fix based on the geopositional data to the database; and
a circuit for correlating the geopositional fix and the database to obtain anticipated movement of the WTRU.

15. The wireless communications system of claim 14 wherein the circuit for correlating the geopositional data obtains said anticipated movement by empirical determination of a probability of the WTRU moving to a location by correlating the positional fix and a travel vector of the WTRU with said database, said database containing statistics on the subsequent travel of previous WTRUs at that location and moving in that direction.

16. The wireless communications system of claim 13, wherein the circuit for obtaining geopositional data on the WTRU receives data generated by a GPS receiver in the WTRU, the data generated by the GPS receiver in order to obtain a geopositional fix based on the geopositional data.

17. The wireless communications system of claim 16, wherein:
the database includes data concerning a correlation of the geopositional data and anticipated movement; and
the circuit for correlating the geopositional data further correlates the geopositional data with anticipated movement as indicated by the data concerning the correlation of geopositional data and anticipated movement.

18. The wireless communications system of claim 13 wherein said anticipated movement of said WTRU is obtained by determining a path of the WTRU and correlating the path with data concerning known paths contained within said database and thereby determining an anticipated path of the WTRU.

19. The wireless communications system of claim 13, wherein the circuit for obtaining geopositional data on the WTRU uses signal measurements at the base station in calculating the geopositional data.

20. The wireless communications system of claim 13, further comprising using fixed monitors to provide measurements for the database.

21. A wireless transmit/receive unit (WTRU) capable of controlling signal parameters, comprising:
a circuit for establishing a signal connection with at least one base station;
a circuit for obtaining geopositional data and providing the geopositional data to said base station;
a circuit for receiving correlated data based on the geopositional data, the correlated data providing signal control parameters based on anticipated movement of the WTRU.

22. The WTRU of claim 21, wherein the circuit for obtaining the geopositional data and providing the geopositional data to said base station further calculates movement of the WTRU and provides data concerning movement of the WTRU.

23. The WTRU of claim 21, wherein the circuit for obtaining geopositional data on the WTRU receives data generated by a GPS receiver in the WTRU, the data generated by the GPS receiver in order to obtain a geopositional fix based on the geopositional data.

24. The WTRU of claim 21, further comprising a circuit for generating signal adjustments in response to the signal control parameters in combination with sensed actual signal changes, so as to increase response to actual changes by using estimations based on the correlated data.

25. The WTRU of claim 21, further comprising a circuit, responsive to the signal controls, for reducing a number of signal adjustments executed by the WTRU by using said signal control parameters based on the anticipated movement.
